(19) United States
(12) Patent Application Publication
(10) Pub. No.: US 2006/0020722 A1
(43) Pub. Date: Jan. 26, 2006

(54) Circuit of a serial communication port pair

(75) Inventor: Alvan Lee, Taoyuan (TW)

Correspondence Address: Eric D. Cohen;Welsh & Katz, Ltd., 22nd Floor, 120 South Riverside Plaza, Chicago, IL, 60606, US

(73) Assignee: Delta Electronics, Inc., Taoyuan (TW)

(21) Appl. No.: 10/950,052

(22) Filed: Sep. 24, 2004

(30) Foreign Application Priority Data
Jul. 23, 2004 (TW) 93122139

(51) Int. Cl. G06F 13/14

(52) U.S. Cl. 710/62

(57) ABSTRACT

A circuit of a serial communication (COM) port pair is disclosed, in which a first and a second serial COM ports and an isolation module are provided, wherein the first and second serial COM ports are arranged at a first and a second devices respectively and the isolation module is arranged between the first and second COM ports and is provided with a power supply by acquiring a signal at a DTR pin and a signal at a TXD pin of the serial COM port of the first device when the first and second devices are ready for data transmission there between in a handshake.

### BACKGROUND OF THE INVENTION

1. Field of Invention

The present invention relates to a circuit of a communication (COM) port pair, and particularly to a circuit of a serial COM port pair with capability of voltage level conversion.

2. Related Art

With the development of information technology, electric products have a tendency of being controlled by a computer. The computer often controls these electric products (loads) through a communication interface, such as a serial communication port RS232 by transmitting related data or commands. To avoid problems with one of the computers or the load end because of a breakdown occurring one of the two devices, an isolation circuit is often included in this case. For example, such an isolation circuit is often used in a control circuit of a frequency switch to reduce damage resulted from short circuiting occurred in a power supply of the load or a load corresponding to the frequency switch. In case two serial data transmitting devices with a long distance difference are directly in connection with each other, a mismatched current is generated between the two devices, due to a mismatched ground voltage between the two devices, and thus a ground loop is formed between the two devices. In this case, the produced electrical energy owing to the ground loop may bring harm to the two devices and an isolation circuit is thus utilized to fully isolate the serial COM ports of the two devices. Generally, an isolated DC-DC converter in the control circuit of the frequency switch is often used to provide a fully isolated power supply to the isolation module at the serial COM port of the controlling computer since the serial COM port RS232 of the controlling computer is not fed with any power supply. Since two control signals in the serial COM port of the computer and the frequency switch respectively have different voltage levels, a voltage level conversion IC is thus used to equalize the voltage levels at the two devices to facilitate signal transmitting and controlling operations.

However, this isolation circuit requires at least the DC-DC converter and the voltage level conversion IC and the cost is relatively high. Therefore, it is an urgent need to develop a simple and low-cost circuit of a serial COM port pair.

### SUMMARY OF THE INVENTION

It is, therefore, an object of the present invention to provide a circuit of a serial communication (COM) port pair between a first device and a second device, in which an isolation module is provided in the circuit and a power supply is provided to the isolation module in the circuit by acquiring signals at pins of a serial COM port of the first device to simplify the circuit of the COM port and reduce circuit costs.

To achieve the afromentioned subject, the circuit of the serial COM port according to the present invetion comprises a first serial COM port having a plurality of pins used for data transmission based on a communication protocol in a handshake, a second serial COM port used for data transmission with the first serial COM port based on the communication protocol in the handshake and an isolation module connected between the first and second serial COM ports and used to keep a signal at one of the two serial COM ports from entering the other one of the two serial COM ports.

The present invention also discloses a method of acquiring an isolated power supply required for an isolation module of a circuit of a serial COM port pair arranged between a first device and a second device and comprising a first serial COM port at the first device and a second serial COM port at the second device, comprising the steps of acquiring a signal at a DTR pin and a signal at a TXD pin of the first serial COM port, connecting the DTR and TXD pins of the first serial COM port respectively to the isolation module in the circuit of the serial COM port pair, outputting a high voltage level signal at the DTR pin of the first serial COM port when the serial COM port is ready for data transmission to provide the power supply to the isolation module of the circuit of the serial COM port pair and outputting a high voltage level signal at the TXD pin of the first serial COM port when the first serial COM port transmits data to provide the isolated power supply to the isolation module of the circuit.

The method of acquiring an isolated power supply required for the isolation module according to the present invention is achieved by use of the voltage levels of the signals at the pins of the first serial COM port and the circuit of the serial COM port pair according to the present invention, and thus achieves the purpose of a simplified circuit and reduced circuit costs.

Other principles and features of the present invention will be further understood with reference to the following description and drawings.

The features and implementations of the invention will be explained in detail by way of preferred embodiments in connection with drawings, as follows.

### BRIEF DESCRIPTION OF THE DRAWINGS

The invention will become more fully understood from the detailed description given hereinbelow illustration only and thus does not limit the invention, wherein:

FIG. 1 is a schematic architecture of a circuit of a serial communication (COM) port pair according to the present invention;

FIG. 2 is a schematic circuit of the serial COM port pair according to the present invention; and

FIG. 3 is a flowchart of a method of acquiring an isolated power supply to an isolated module in the circuit depicted in FIG. 1 and FIG. 2.

### DETAILED DESCRIPTION OF THE INVENTION

The features and implementations of the present invention will be described in detail with preferred embodiments in connection with the drawings

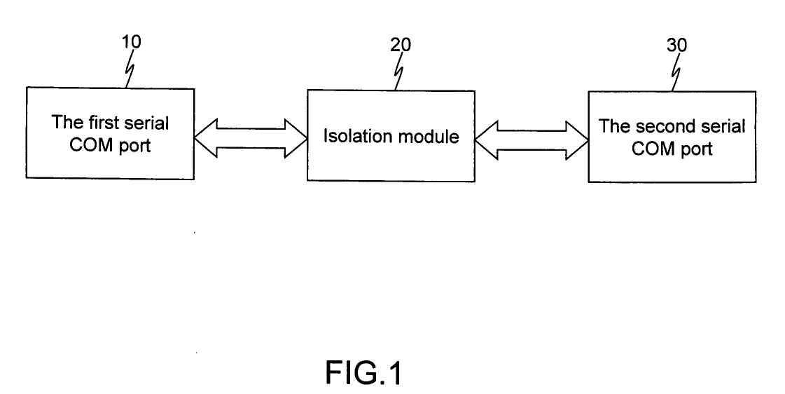

A circuit of a serial communication (COM) port pair according to the present invention will be described with reference to FIG. 1. Referring to FIG. 1, the serial COM port pair comprises a first serial COM port 10, a second serial COM port 30. The circuit of the serial COM port pair comprises the serial COM port pair 10, 30 and an isolation module 20, wherein a first device, having the first serial COM port 10, controls a second device, having the second serial COM port 10. The circuit of the serial COM port pair is used to provide a damage-protection, as mentioned above, in the controlling operation.

In the controlling operation, pins of the first and second serial COM ports respectively are used for data transmission there between in a specific communication protocol in a handshake corresponding to the controlling operation. Hereinafter, the first and second devices will be described with a computer and a frequency switch. Namely, the frequency switch is controlled by the computer to achieve a computer controlled frequency switch.

Now, the following statements are dedicated to an introduction to pins of the first serial COM port, which are also pins of the second serial COM port since the first and second serial COM ports are totally identical to each other. The pins of the first serial COM port comprise a DCD (data carrier detect) pin used to detect a data carrier, a RXD (received data) pin used to receive data, a TXD (transmit data) pin used to transmit data, a DTR (data terminal ready) pin, being an output terminal and meaning the TXD pin is ready for transmitting data when a signal therein is activated, a GND (ground) pin, a RTS (request to send) pin, being an input terminal and meaning the RXD pin is ready for receiving data when a signal therein is activated, a CTS (clear to send) pin, being an output terminal and used to request the input of data and a RI (ring indicator) pin used to detect a ring.

Each of the first and second serial COM ports 10, 30 may be a serial port RS-232 interface of the computer or the frequency switch as a communication interface there between. For a basic controlling operation of the computer on the frequency switch, at least the RXD, TXD and GND pins are respectively required in the first and second serial COM ports 10, 30 to perform a corresponding data transmission operation based on a specific communication protocol in a handshake corresponding to the controlling operation.

The isolation module 20 is connected to the first serial COM port 10 at one side and connected to the second serial COM port 30 at the other side to isolate the first and second serial COM ports so that a signal transmitted in one of the two serial COM ports may not enter the other of the two serial COM ports. The isolation module 20 has an input terminal and an output terminal not in electrical connection with each other. Specifically, the isolation module 20 may be formed with a photo-coupled transistor switch and any signal transmitted between the input/output terminals of the isolation module 20 is transmitted in a light form. Therefore, when the serial COM port of one of the computers and the frequency switch at one side of the isolation module 20 is broken, the serial COM port of other computers and the frequency switch may not be damaged.

When the serial COM ports of the computer and the frequency switch are ready to go on a handshake, the pin DTR corresponding to the computer presents a high voltage level signal (about +10V) and the pin TXD corresponding to the computer presents a low voltage level signal (about −10V) when no data are transmitted. The signals at the pins DTR and TXD respectively are used as a positive voltage level and a negative voltage level to provide an isolated power supply to the isolation module 20 and a low voltage level signal to the pin RXD 103 of the first serial COM port 10 respectively.

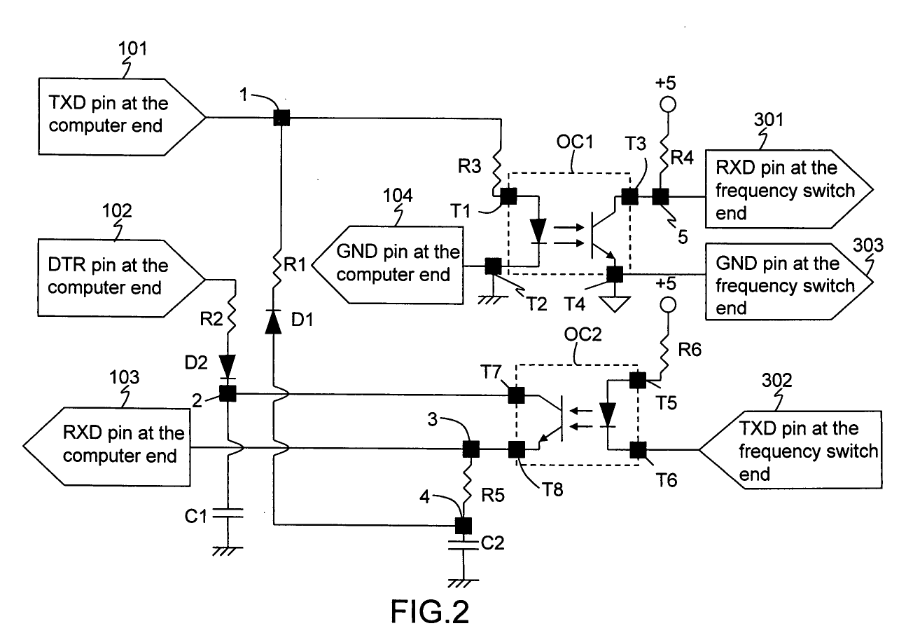

Referring to FIG. 2, a circuit diagram of the serial COM port pair is illustrated therein. As shown, the circuit comprises a TXD pin 101, a DTR pin 102 and a RXD pin 103 and a GND pin 104 in the computer end, a RXD pin 301 and a TXD pin 302 in the frequency switch end, a first photo-coupled transistor switch OC1, a second photo-coupled transistor switch OC2, a first capacitor C1, a second capacitor C2, a first diode D1, a second diode D2, a first resistor R1, a second resistor R2, a third resistor R3, a fourth resistor R4, a fifth resistor R5 and a sixth resistor R6, in which each of the diodes D1,D2 is used to avoid a reversed current therein, each of the capacitors C1,C2 is used to stabilize a voltage thereon and each of the resistors R1, R2, R3, R4, R5, R6 is provided to limited a current therein.

In the circuit, the TIX pin 101 at the computer end is connected to a node 1, the first photo-coupled transistor switch OC1 is connected to the node 1 at a p end of a light emitting diode (LED) thereof through the third resistor R3, connected to the GND pin 104 at the computer end at an n end of the LED thereof, connected to a fifth node 5 at a T3 end of a transistor therein and connected to the GND pin 303 at the frequency switch end at a T4 end of the transistor therein. The above connections form one of the loops between the computer and the frequency switch ends.

Next, a +5V voltage source is connected to the fifth node 5 through the fourth resistor R4 and the RXD pin 301 at the frequency switch end. The first resistor R1 and the first diode D1 are connected between the first node 1 and the fourth node 4, the first diode D1 is connected to the fourth node 4 at a p end thereof and connected to one end of the first resistor R1 at an n end thereof. The first resistor R1 is connected to the first node 1 at the other end, The DTR pin 102 at the computer end is connected to one end of the second resistor R2. The second resistor R2 is connected to a p end of the second diode D2 at the other end, an n end of the second diode D2 is connected to the second node 2, the second photo-coupled transistor switch OC2 is connected to a second node 2 at a T8 end of the transistor thereof. The fifth resistor R5 is connected between the third node 3 and the fourth node 4, the second capacitor C2 is connected to the fourth node 4 at one end and connected to the GND pin 104 at the other end, the RXD pin 103 at the computer end is connected to the third node 3, the first capacitor C1 is connected to the second node 2 at one end and connected to the GND pin 104 at the computer end at the other end, the second photo-coupled transistor switch OC2 is connected to the +5V power source at the p end of the light emitting diode (LED) thereof through the sixth resistor R6 and connected to the TXD pin 302 at the frequency switch end at the n end of the LED thereof.

The circuit of the serial COM port pair is operated as follows.

When the computer and the frequency switch are in a standby mode, the TXD pin 101 presents a high voltage level signal and a corresponding current is flown through the third resistor R3 and the LED of the first photo-coupled transistor switch OC1 to the GND pin 104, enabling the LED and the transistor in the first photo-coupled transistor switch OC1 to emit a light and be turned on respectively. At this time, the RXD pin 301 at the frequency switch end presents a low voltage level signal and is defined as logic “1” by the frequency switch.

When the computer does not transmit data, the TXD pin 101 at the computer end presents a low voltage level signal, the transistor in the first photo-coupled transistor OC1 is not turned on and the RXD pin 301 at the frequency switch end presents a high voltage level signal and is judged as logic “0” by the frequency switch. In addition, the RXD pin 103 at the computer ends also presents a low voltage level signal since the first diode D1 is turned on.

When the frequency switch is ready to transmit data, the TXD pin 302 presents a low voltage level signal and a corresponding current is flown through the sixth resistor R6 and the LED in the second photo-coupled transistor switch OC2 enabling the LED and the transistor therein to emit a light and be turned on. When the computer and the frequency switch are ready to go on a handshake in a specific communication protocol, the DTR pin 102 presents a high voltage level signal enabling a current to flow through the second resistor R2, the second diode D2, the second photo-coupled transistor switch OC2 to the RXD pin 103. Therefore, the RXD pin 103 presents a high voltage level signal. In the computer, a high voltage level signal is judged as the logic “0” and a low voltage level signal as the logic “1”. With this, any high and low voltage level signal in the RXD pin 103 may be obtained by the computer, and thus the prior voltage level converter may be replaced.

When the frequency switch does not transmit data, the TXD pin 302 presents a high voltage level signal and the transistor in the second photo-coupled transistor switch OC2 is not turned on, enabling the RXD pin 103 to present a low voltage level signal judged by the computer as logic “0”.

Therefore, communication based on a specific communication protocol in the handshake may be achieved in the aforementioned manner. In addition, each of the diodes in the circuit of the serial COM port pair may be replaced with a zener diode.

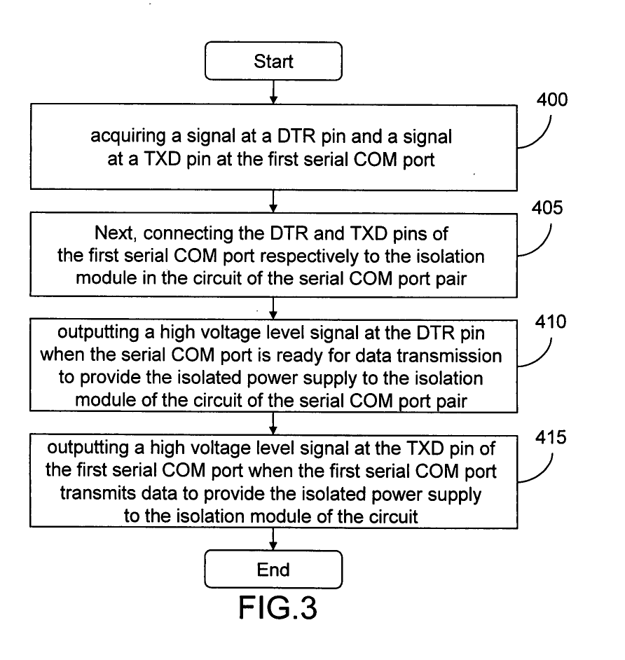

Referring to FIG. 3, a flowchart of the method of acquiring an isolated power supply to the isolation module of the circuit of the serial COM port pair comprising a first and a second serial COM ports depicted in FIG. 2 is illustrated therein. First, acquiring a signal at a DTR pin and a signal at a TXD pin at the first serial COM port (400). Next, connecting the DTR and TXD pins of the first serial COM port respectively to the isolation module in the circuit of the serial COM port pair (405). Next, outputting a high voltage level signal at the DTR pin when the serial COM port is ready for data transmission to provide the isolated power supply to the isolation module of the circuit of the serial COM port pair (410). Then, outputting a high voltage level signal at the TXD pin of the first serial COM port when the first serial COM port transmits data to provide the isolated power supply to the isolation module of the circuit (415).

With the circuit of the serial COM port pair and the method of acquiring an isolated power supply to the isolation module in the circuit, the DC-DC converter and voltage level converter used in the prior circuit may be omitted and thus the purposes of a simplified circuit and reduced circuit costs may be achieved.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments, which do not depart from the spirit and scope of the present invention.

1. A circuit of a serial COM port pair, comprising:
a first serial COM port;
a second serial COM port used for data transmission with the first serial COM port based on a communication protocol in a handshake; and
an isolation module connected between the first and second serial COM ports and used to block a signal at one of the two serial COM ports from entering the other one of the two serial COM ports.

2. The circuit as recited in claim 1, wherein the isolation module comprises at least one photo-coupled transistor switch.

3. The circuit as recited in claim 1, wherein the first serial COM port comprises a TXD pin, a RXD pin, a DTR pin and a GND pin.

4. The circuit as recited in claim 3, wherein the DTR pin presents a high level signal when the first serial COM port are ready for the data transmission and connected to the RXD pin through the isolation module.

5. The circuit as recited in claim 3, wherein the TXD pin presents a low level signal when the first serial COM port does not transmit data and is connected to the TXD pin and a RXD pin.

6. The circuit as recited in claim 3, wherein the TXD pin present a high level signal when the first serial COM port is in the data transmission.

7. The circuit as recited in claim 1, further comprising a diode switch circuit used to block a reverse current to protect the first serial COM port.

8. The circuit as recited in claim 7, wherein said diode switch circuit further comprises a first resistor and a first diode connected between a first and a fourth nodes, wherein the first diode is connected to the fourth node at a p end thereof and connected to an end of the first resistor at an n end thereof, the first node is connected to one end of the first resistor at the other end, the DTR pin at the computer end is connected to one end of a second resistor, the second resistor is connected to a p end of the second diode at the other end and an n end of the second diode is connected to a second node.

9. The circuit as recited in claim 8, wherein the first diode of the diode switch circuit is a zener diode.

10. The circuit as recited in claim 8, wherein the second diode of the diode switch circuit is a zener diode

11. The circuit as recited in claim 7, wherein the diode switch circuit further comprises a first capacitor connected to a second node at one end and connected to the a GND pin of the fist serial COM port at the other end.

12. The circuit as recited in claim 7, wherein the diode switch circuit further comprises a fifth resistor connected between a third node and a fourth node and a second capacitor connected to the fourth node at one end and connected to the GND pin of the fist serial COM port at the other end.
